(19) United States
(12) Patent Application Publication
(10) Pub. No.: US 2021/0090300 A1
(43) Pub. Date: Mar. 25, 2021

(54) A METHOD TO QUANTIFY FIRE RISK TO STRUCTURES

(71) Applicant: Oy Arbonaut Ltd., Joensuu (FI)

(72) Inventors: Vesa Leppänen, Katajaranta (FI); Alejandro Barrios Becerra, Joensuu (FI)

(73) Assignee: Oy Arbonaut Ltd., Joensuu (FI)

(21) Appl. No.: 16/772,267

(22) PCT Filed: Dec. 11, 2018
(86) PCT No.: PCT/FI2018/050897

§ 371 Date: Jun. 12, 2020

(30) Foreign Application Priority Data
Dec. 12, 2017 (FI) 20176110

(51) Int. Cl. G06T 7/00; G06Q 50/08; G01S 17/89; G06T 7/62

(52) U.S. Cl. CPC G06T 7/97; G06Q 50/08; G06Q 10/0635; G06T 7/62; G06T 2207/30188; G01S 17/89

(57) ABSTRACT

A system and method of quantifying fire risk posed by vegetation or other types of fire fuels to structures and a process for facilitating the measurement are disclosed. The method utilizes protection perimeter zones around the structures, summarizing vegetation information within the zones and analyzing fire risk to structures.

### DESCRIPTION OF BACKGROUND

The following disclosure relates to quantifying fire risk to structures. Particularly, the disclosure relates to a system and method of quantifying fire risk posed by vegetation or other types of fire fuels to structures and a process for facilitating the measurement.

Quantifying fire risk to structures is critical to effective fire management operations that may include fire response and fire prevention tasks among other tasks. There are many reasons why organizations and individuals are interested in the risk quantification; including but not limited to:
Making decisions whether to protect a certain structure in case of a fire or to not protect it
Communicating to the structure management or ownership about the fire risk level
Making decisions of managing vegetation that may pose a risk of fire to structures
Deciding on evacuations of people, life and material from structures in case of fire.

Some examples of fire management operations where the fire risk quantification is interesting for the organizations or individuals:
Firefighting/Fire response; a risk rating value on structures would allow more structured and well-based decisions.
Fire prevention; identification of the risk value and the vegetation that has an impact on the risk would allow more efficient prioritization of the vegetation management.
Buying property; high fire risk rating may have an effect on property prices, especially on areas with high fire probability. Also, well managed risk may increase the property value.
Renting property. It may be useful for the tenants to understand the risk, in case there is a fire in the area, they can make better based decisions on saving life and property
Financing property. Properties with high fire risk may include an additional risk element to be managed by insurances etc.
Insuring property. Insuring agent may be interested in the fire risk to the property they have insured. Good communication tends to be a useful method to decrease the risk.
Buying or selling insurance to property. It is important for both insurance taker and awarder that the risk level is known.
Using property as collateral. It may be of interest of the mortgage agent to understand the risk of damage to the collateral value.

Quantifying fire risk to structures, posed by vegetation, is a challenge in many fire management operations. However, it is not easy to obtain such information in large scale.

Fire fuel is material that can be burned in right conditions. Typically, certain energy content per volume of space has to be achieved to sustain a fire in a certain location. The energy content per volume of space is called fire fuel density. Sometimes, fire fuel density is measured in kg/m3 or in kWh/m3, when fuel per volume unit is measured. It is common to measure fire fuels as amount of fuel per area of volume where also the space between the fuel particles are calculated to the volume; for example, you take one cubic meter of forest nature and calculate the energy or mass of all fuel in that space. Sometimes, fuel density per area of surface (for example ground surface) is measured. Units like tons/ha or kg/m2 or kWh/m2 can be used for this kind of measurements. Measuring the fire fuel density has been a challenge historically, due to large amount of work involved to the measurements.

Continuity of fuel from the potential large fuel source to the structure of interest may be interesting in terms of fire management. A gap in fuel continuity may slow or stop the fire procession, allowing effective management of the fire and protection of a structure. However, measuring the fuel continuity in large scale is difficult using conventional technical measurement methods and devices.

Remote sensing is an art known to mankind. Remote sensing may be performed using for example satellite or airborne sensors, operated from manned or unmanned vessels. Remote sensing has been done from land and water vehicles as well as from airborne vessels or spacecraft. Sensors most commonly used include spectral sensors (cameras, spectrometers etc.), LiDAR sensors and radar sensors, but other kinds are known to be used as well.

Remote Sensing has capability to produce information about vegetation. This information may be geographically two-dimensional or three dimensional, but can also include more dimensions, like time. Some examples of information related to fire management, achieved from remote sensing, include the fire fuel density and continuity, mentioned above.

Three dimensional point clouds have been used quite extensively in sensing. Point clouds can be produced using multiple techniques, LiDAR, photogrammetry and radargrammetry being just a few. A brief presentation of some of the techniques area presented here.

Photogrammetry is the science of making measurements from photographs. Stereophotogrammetry is a methodology of Photogrammetry where group of two or more images taken of the same target are analyzed. The images are taken from different viewpoints, presenting the objects at different distance from the observing sensors at different locations in the imaging sensor. Corresponding features are identified in different images and their relative location on the image are interpreted to extract the 3D location of the objects. The sensor locations may be given to the algorithm or, alternatively, deduced from the analysis.

LiDAR, known also as laser scanning, has been used for forest inventories approximately since 1990's, but somewhat longer time in topographic analysis. LiDAR is an active instrument that uses laser ranging, combined with devices measuring position and attitude of the sensor, to produce 3D location measurements of objects. The sensor emits a laser beam to a known direction from a known position and records the distance to surfaces where the beam is reflected back. Additionally, LiDAR may have capability to record the intensity of the returning signal, indicating the reflectivity and size of the reflecting surfaces. The laser beam is projected to the object through a mirror or prism system or other kind of optical setup (the “LiDAR Optic”) that causes the laser beam to scan the target area, recording the precise direction where the beam was sent each time to allow construction of the 3D measurements.

LiDAR has been further developed to use an array of laser beams instead of a single beam. The array may be stationary or scan the targeted area. However, the system yields a set of three dimensional coordinates and potentially some information of the reflectivity. Information from this kind of a sensor is substantially similar to the information received from a traditional single-beam LiDAR and embodiments presented in this publication are applicable as such.

LiDAR has been improved also by adding lasers of different light bandwidth. These sensors are capable of measuring the intensity of the returning pulses at different bandwidths, and can yield information about the target reflectivity on different bandwidths. Despite this additional spectral information, the data is similar to the data from traditional single beam LiDAR, and can be processed as such in the presented process.

Traditionally, LiDAR has been used to produce attributes to areas of land. For example, LiDAR-derived attributes have been assigned to timber stands, making management or inventory units.

Because of its capability to measure vegetation height and canopy densities, LiDAR has been widely accepted in forest inventory purposes, but is also used in fire fuel mapping. A typical product from fire fuel mapping process with LiDAR is a two-dimensional fire fuel map presenting amount of fire fuel per each pixel or analysis cell.

Radargrammetry is the technology of extracting geometric object information from radar images. The output of the radargrammetric analysis may be for example a geometric three dimensional point cloud. Like stereophotogrammetry and LiDAR, also radargrammetry can be used from airborne or satellite, ground and water vessel platforms.

Fire fuels have been mapped to make grid or raster fuel maps for target areas, including for example fuel density, vertical fuel continuity and horizontal fuel continuity (See for example: Andersen, H-E, MCGaughey, R. and Reutebuch, S. 2005. Estimating Canopy Fuel Parameters from LiDAR Data. Remote Sensing of Environment 94 (2005) 441-449). However, the focus of these studies is in making maps of fire fuels, not in protecting the structures. Thus, the fuel has been quantified on grid cells that, typically, are squares or of some other uniform shape. Conversely, the data densities available for large areas force the use of fairly large analysis cells to achieve enough data points from each cell for an accurate quantification. For example, 10-25 m resolution of cells are commonly used in LiDAR-based fuel mapping, and even lower resolution for medium or low resolution satellite fuel mapping. Depending on the desired analysis precision and available source data, different analysis cell sizes may be used; 10-25 m resolution cells may be sufficient for overall mapping of fuels, while some analysis may demand much more detailed mapping. For example, 0.5-5 m resolution may be sufficient to identify fuel gaps around buildings, in some conditions effectively slowing the fire spread from vegetation areas to structures. Traditionally, the analysis has happened from the view point of the fuels, not from the view point of the structures to protect.

Thus, there is a need for improving methods for quantifying fire risk to structures.

### SUMMARY

This disclosure discloses an approach, method and a process to analyze the fire risk from the viewpoint of a structure, presenting a method to achieve accurate fuel continuity predictions related to structures from relatively low density of vegetation data inputs.

The method differs from the methods known to mankind before by using the structure as the source geometry of the protection perimeter zones, summarizing the vegetation information in each zone to a statistic related to the zone and analyzing risk to structures as a function of the vegetation statistic. It improves the risk quantification significantly in level of individual structures where other quantification may be inaccurate, impractical or costly to acquire.

In an aspect a method of quantifying fire risk to structures is disclosed. The method comprises receiving locations of structures of interest; receiving vegetation information; producing geometric perimeter zones to the proximity of the structures; summarizing vegetation information within the produced perimeter zones; and analyzing fire risk to the structures of interest based on summarized vegetation information.

It is beneficial to use a method as disclosed above for quantifying fire risk to structures disclosed. The method provides additional information for analyzing the risk that can be taken into account in transactions and also provides means for improving the level of fire risk by identifying the points causing the fire risk so that they can be removed or at least the risk can be reduced.

In an implementation the vegetation information is data received from remote sensing. It is beneficial to use remote sensing as it provides an easy way of acquiring information covering whole area to be analyzed.

In an implementation at least a portion of the vegetation information is derived from data acquired by LiDAR sensor. In another implementation at least a portion of the vegetation information is derived from data acquired by photogrammetry. It is beneficial to use known approaches for remote sensing as they provide reliable information. Furthermore, in some implementations it may be useful to combine these two and possibly with additional sensing mechanism.

In an implementation the method further comprises receiving protection perimeter zone type and width, producing the said perimeter zones according to the received zone type and width; still summarizing vegetation information within the produced perimeter zones; and analyzing fire risk to the structures of interest based on summarized vegetation information. It is beneficial to use the perimeter zone type and width in the analysis as it improves the accuracy of the quantification.

In an implementation the summarizing of the vegetation information is done using an optimization algorithm to find at least one path for the fire to cross the perimeter zone to the structure. It is beneficial to use optimization algorithm for determining paths that the fire could use. Determination of the paths provides reliability to the estimate and provides also information where the fire risks can be reduced by removing the possible path.

In an implementation the method further comprises receiving a reference measurement; performing model calibration between summarized vegetation information and the Reference Measurement; and performing calibrated fire risk quantification calculation. It is beneficial to calibrate the measurement so that the reliability is increased.

In an aspect a system comprising at least one processor and data communication connection is disclosed. The system is configured to perform a method disclosed above.

In an aspect a computer program comprising computer program code is disclosed. The computer program is configured to cause a computing device to perform a a method as disclosed above when the computer program is executed in a computing device.

The above disclosed methods, system and computer program improve quantifying fire risk in buildings and areas. The quantified information can be used in order to improve the general fire risk situation of the building or area. This can be improved as the methods can be used to point out the reasons for increased fire risk so that by removing

### BRIEF DESCRIPTION OF THE DRAWINGS

The accompanying drawings, which are included to provide a further understanding of the system and method to quantify fire risk posed by vegetation or other types of fire fuels to structures and constitute a part of this specification, illustrate embodiments and together with the description help to explain the principles of the system and method of quantifying fire risk to structures. In the drawings:

FIG. 1 presents a block diagram of an example embodiment of the process of quantifying fire risk to a structure,

FIG. 2 examples of embodiments of structure perimeter geometries,

FIG. 3 additional examples of embodiments of structure perimeter geometries are disclosed, and

FIG. 4. Example of summarizing the vegetation information by an optimization algorithm, finding minimum time path from the external boundary of the perimeter to the structure.

### DETAILED DESCRIPTION

Reference will now be made in detail to the embodiments, examples of which are illustrated in the accompanying drawings.

In the following description system and method of quantifying fire risk posed by vegetation or other types of fire fuels to structures is disclosed.

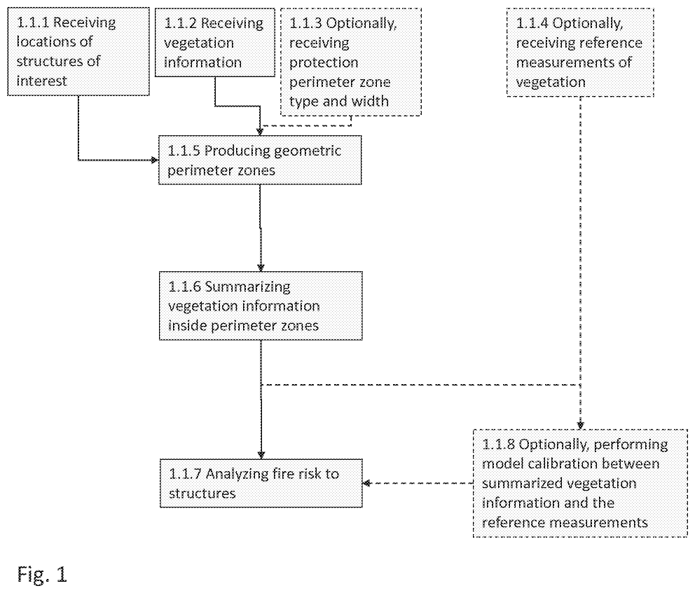

FIG. 1 presents a block diagram of an example embodiment of the process of quantifying fire risk to a structure. The following method is explained with referrals to FIG. 1.

A system and method of quantifying fire risk posed by vegetation or other types of fire fuels to structures and a process for facilitating the measurement are disclosed. FIG. 1 presents the process of quantifying fire risk to a structure. The process receives locations of structures of protection 1.1.1, vegetation information 1.1.2, protection perimeter zone type and width 1.1.3 and optionally, reference measurements of vegetation 1.1.4.

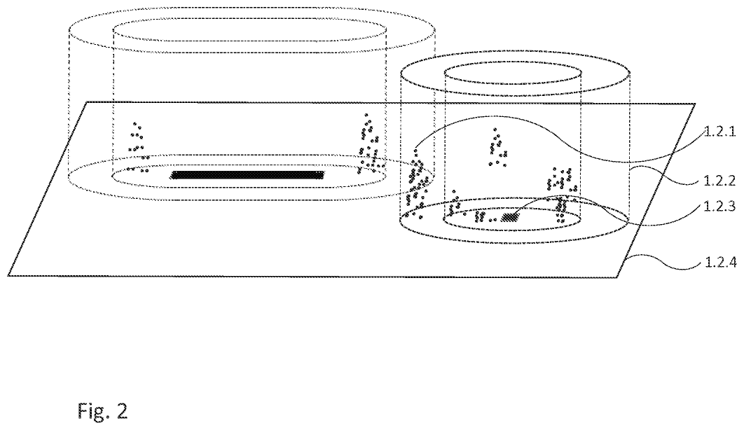

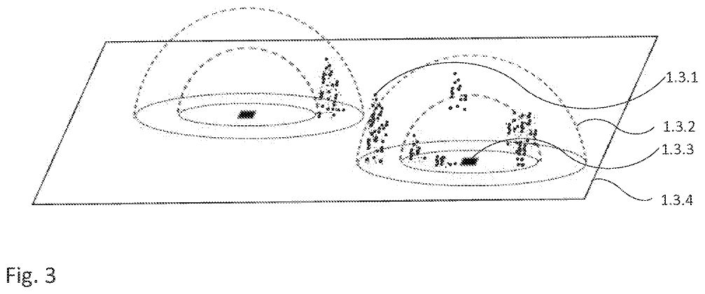

Analysis of producing geometric containers of perimeter zones 1.1.5 is performed to identify the locations that are the most interesting in terms of fire risk to the structures. The containers are geometric two-dimensional areas or three-dimensional volumes that can be of varying shapes. Some example shapes are presented in FIGS. 2 and 3 Summarizing vegetation information inside perimeter zones 1.1.6 is done by making statistics of the vegetation information within the zones. Depending on the nature of vegetation information 1.1.2, the analyzing risk to structures 1.1.7 may be done directly based on the statistics produced to the perimeter zones or, optionally, may utilize the phase of performing model calibration between summarized vegetation information and the reference measurements 1.1.8, where the summarized vegetation information is further developed to usable risk metrics.

Receiving Locations of Structures of Interest 1.1.1

Receiving locations of structures of interest may be done in many different ways. While manual input of location data is possible, a practical way may be to receive location files identifying the locations of the structures. In one embodiment, these structures may be houses, other buildings or structures of infrastructure. The location information may be just individual two-dimensional or three-dimensional point locations, but may also be vectors, polylines or polygons in two-dimensional or three-dimensional domain. Further on, the shape of the three-dimensional structures may be presented as a three-dimensional set of locations, for example, a CAD drawing.

The format of the locations of structures of interest may be for example, but is not limited to the following formats:
Raster image, containing the information as image cells.
Point location records, possibly connected with attributes
Vectors, possibly connected with attributes
Polylines, possibly connected with attributes.
Polygons of any free form, possibly connected with attributes.
Three dimensional drawings of any free form, possibly connected with attributes.

All above formats may be in two-dimensional or three-dimensional domain and practically stored in a database or an information file.

Receiving Vegetation Information 1.1.2

Acquiring information of vegetation has been done by mankind at least since fruits have been eaten from trees. For example, in fire management processes, information about the fire fuels have been collected in the field, using satellite or aerial image data but also, practically, using LiDAR (Light Detection and Ranging). For example, Andersen et al. present a method to collect fire fuel information in forest canopies with LiDAR (Andersen, H-E, MCGaughey, R. and Reutebuch, S. 2005. Estimating Canopy Fuel Parameters from LiDAR Data. Remote Sensing of Environment 94 (2005) 441-449.)

Some examples of embodiments of vegetation information can be, but are not limited to:
height
density
volume
biomass
dry weight
dryness
water percentage
relative humidity
leaf area index LAI
normalized differentiated vegetation index NDVI
Particle size
energy content
canopy density
canopy base height
fire fuel density per area or per volume
fire fuel quantity.

LiDAR presents a practical way to receive vegetation information useful in the process of quantifying fire risk to structures, by providing cost efficient ways to measure the density and three-dimensional distribution of fire fuels. Alternatively, stereogrammetry or image analysis from satellite or aerial imagery may be used to receive such information. No matter what is the source of the vegetation information, it is important that the information contains quantity and location of the fire fuels. A person or team skilled in the art of fire fuel mapping is capable of producing such vegetation information.

In one embodiment, a raster image may be used to store the information, each pixel presenting the values of attributes of interest. In another embodiment, a grid data may be used, where geometries are presenting the extent of each information unit and attributes are indicating the values of interest. Further on, in one practical embodiment, the vegetation information consists of LiDAR point cloud presenting vegetation and other objects in the area of the perimeters.

In one more embodiment, the vegetation information may be produced to a voxel map, presenting three-dimensional voxels attributed with vegetation information or fire fuel information.

One practical approach of acquiring information on vegetation with remote sensing is to cover the area of interest with remote sensing data, connect it to some measurements of the vegetation, making a model to predict the vegetation properties over the entire area of interest.

There are other approaches to acquire information on vegetation, but the methods mentioned here disclose the idea of this phase. In examples of this description, the vegetation information is received from some remote sensing process.

The format of the Cells of Work Quantification Information may be for example, but is not limited to the following formats:
Raster image, containing the information as image cells.
Polygons in a systematic grid of squares or hexagons or triangles, connected with attributes.
Polygons of any free form, connected with attributes.
Point location records, connected with attributes
Three dimensional voxel records, connected with attributes

All above formats may be practically stored in a database or an information file.

Receiving Protection Perimeter Zone Type and Width 1.1.3

The fire risk may be quantified using different kinds of perimeter zones, out of which a few examples are presented here.

A two-dimensional polygon may contain a perimeter zone. However, it can be also extruded vertically to contain a three dimensional area. Three-dimensional perimeters may be formed in many ways, for example extruding two-dimensional structure information or directly as a three dimensional proximity.

In one embodiment, the three dimensional perimeters are formed to respond to the directionality of the risk. For example, fuels below the structure may present more risk than the fuels above the structure due to the nature of flames, having more tendency to expand the fire area upwards. A correspondingly shaped protection zone may be presented.

The zone width defines the size of the zone area considered. In one practical embodiment, multiple zones are presented around the structure, each zone being exclusive of the others. Some zones may be wider than others, potentially presenting also areas where the risk may be lower to the structure.

Producing Geometric Containers of Perimeter Zones 1.1.5

A two-dimensional polygon may contain a perimeter zone. Such perimeters can be formed making several polygons around the structure, some presenting a wider perimeter than others. The zones may be inclusive or exclusive of each other. The zones may be constructed to go around the structure but also may be sectored to contain directions. A two-dimensional perimeter may be analyzed with two-dimensional vegetation data. However, it can be also extruded vertically to contain a three dimensional area.

Three-dimensional perimeters may be formed in many ways, but one practical way is to use a fixed proximity from the structure. This proximity may be formed from two-dimensional structure information (for example a footprint) and extruding to third dimension (FIG. 2), or directly as a three dimensional, presenting a three dimensional buffer of the footprint or the structure geometry.

While there are many ways of making the perimeter zones, and they may take diverse shapes, it is important that they present the proximity of the structures of interest and are formed to identify the vegetation that is critical to the fire risk.

Summarizing Vegetation Information Inside Perimeter Zones 1.1.6

Summarizing vegetation information inside perimeter zones 1.1.6 is done to connect the vegetation information that is of interest to the fire risk to the structure in question. Many kinds of statistics can be used to summarize the information; including, but not being limited to:
sum
mean
median
standard deviation
number of records
number of records at certain elevation zone above ground
density of records per area or per volume
Any other statistic
   Optionally, the summarizing vegetation information inside perimeter zones may be performed using an optimization algorithm; finding the paths 1.4.4 for the fuel to reach the structure 1.4.1 from the external boundary of the perimeter zones 1.4.3. In this process, the each geometric location in the vegetation information 1.4.2 receives a value for the optimization. In one practical embodiment the value may be an estimate of the time it takes for fire to expand some distance in some standard conditions. A value may also be given to the area outside the vegetation information (for example the space between the vegetation). Obviously, it may take much longer time for fire to cross area with no fuels that to cross area with fuel sufficient to carry on fire. In one embodiment, a maximum crossable distance of open space (max jump distance) may also be given; telling to the optimization that fuel free zone wider than the max jump distance cannot be crossed. Optimization may be done to find some or all of the paths where the crossing from the external boundary of the perimeter zone to the structure is possible. Obviously, the paths available may be attributed and ranked based on the time for the fire to cross the perimeter zone from the external boundary to the structure. The paths with lowest time can be seen as the most dangerous fuel connections. In this case, the summarized information may be presented for example in the form of vector connections or a table that presents which pieces of vegetation are connected by a fire path. The paths, no matter what way they are presented, may also be added with some attribute information, describing the said path. Such attribute information may be for example the summarized time crossing the given path; the length of the longest delay caused by the biggest fuel free area crossed by the path etc. Alternatively, in another embodiment, the summarizing vegetation information may be done using optimization, like in the example above, but the value given to each piece of vegetation may be a value related to the energy the vegetation may release if burned (energy content). In this case, the optimization may find the paths from the external boundary of the perimeter zone to the structure may use the energy of each reached piece of vegetation, testing if the distance to the surrounding vegetation areas is such that the energy released from the reached vegetation unit allows to carry the fire to the next vegetation. Essentially, the path of fire is simulated to expand if the energy of the reached vegetation allows lighting the next vegetation. The output may be for example similar as presented already above for the optimized path.

Analyzing Risk to Structures 1.1.7

Analyzing the risk to structures 1.1.7. may be done by comparing the summarized values to any reference or threshold value, reading the risk level from a pre-fabricated table or using a risk model to some of the statistics produced in step 1.1.6.

There may be pre-defined models relating the fire risk to the structures. However, in some embodiments, this judgment is done using threshold values of vegetation summaries to classify the risk to classes. In another embodiments, this classification is done using a table of values as a function of some input variables (vegetation summary values) on the table axles.

In one embodiment, the structures are houses; the fire fuel density is measured in the vegetation information, the zone is a set of extruded two-dimensional buffers of different buffer widths (for example, 5, 10, 15, 20 and 25 m buffer widths), and the statistic calculated is the mean fire fuel density kg/m² in each zone. A person familiar with fire fuel management and fire risk management in wildlife-urban interface might find it quite practical to use this kind of zoned fire fuel density metrics for each house as a tool to present and evaluate fire risk rating for the house. Presenting map information or other kind of presentation of the fire risk to house may have an impact on the behavior of the house owner or manager. Especially, if there is a set risk level or code about acceptable positioning of the vegetation around the house, the analysis results can be compared to the acceptable level and the compliance of the house can be evaluated and communicated to appropriate persons like house owner, manager, insurance agent and fire officials.

In other embodiment, the structure may be a powerline conductor on one tower span. A three-dimensional buffer or set of buffers may be formed around the conductor, to summarize the vegetation metrics, for example the energy content of the vegetation material, measured for example kWh/m³, and to evaluate the fire risk to the conductor. With this kind of fire risk to power network information, it is possible to target vegetation management operations in a way that will decrease the fire risk to the system or maintain it on a desirable level.

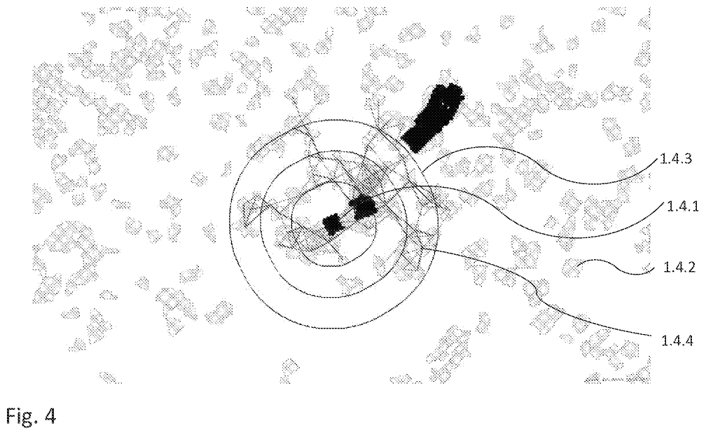

In one embodiment, if the summarizing vegetation information inside perimeter zones was done using optimization and finding paths for the fire to cross over from the external boundary of the perimeter zones 1.4.3 to the structure 1.4.1, the analysis may be consisting of classification of the paths 1.4.4 to usable and non-usable for the fire. In FIG. 4. the paths 1.4.4. are drawn as thick line if the connection is classified as usable in certain set of conditions. If the path is not usable in these conditions, the line is shown with narrower thickness. This usability may, in one embodiment, be depending on the conditions. For example, in a rainy day when vegetation is wet, it may be that a space of 3 meters would not be crossable due to the lack of energy in the neighboring vegetation to heat the wet vegetation in question to a point of transmitting a fire. On dry conditions, it may be deemed that such crossing is possible. In the end, the behavior of the fire is studied by fire scientists; there are many fire transmit models made, explaining fire expansion in given conditions. Often, these models are run on map or geographic information system environments, allowing analysis of fire expansion in the set of given conditions. The fire scientists can make and run many fire behavior models if asked. Additionally, the presentation of fire paths may be usable for the structure manager in identifying the key pieces of vegetation in terms of fire risk. This allows targeting management actions to the most important fire paths.

Optionally, Performing Model Calibration Between Summarized Vegetation Information and the Reference Measurements 1.1.8

Sometimes, the vegetation information may not directly relate to the risk of interest. In case like this, a model may be calibrated to predict the risk-related vegetation information with the measured and summarized vegetation information. The vegetation summaries may be used as independent variables in the model and the risk-related vegetation information may be used as dependent variables.

In practical embodiment, the model is a parametric linear or non-linear model.

In other practical embodiment, the model may be a non-parametric model.

In one embodiment, the vegetation summary (independent variable) is the LiDAR return density from vegetation targets in a proximity of houses, the dependent variable is the fire fuel density in kg/m³ of space and the fire risk is divided into three classes based on the fire fuel density in co-centered zones around the house. If there is more than threshold value of fire fuel density in the 25 m zone around the house, the house is defined as non-defendable. If there is more than another threshold value of fire fuel density in the same zone, the house may be defined as potentially defendable. Further on, if there is less than any of the threshold densities in the same zone, the house may be considered defendable from wildland fire.

In one embodiment of the fire risk quantification to the power line, there is a risk of short-circuiting a line due to relatively high conductive properties of smoke. Thus, another risk rating may be done to evaluate the risk of the fire smoke to cause a power shortage. In this case, an optional model may be used to the statistics to generate the smoke quantification and its effect to safety distances of the line.

FIG. 2 shows examples of embodiments of structure perimeter geometries. In the figure Bottom projections of structures are presented in two dimensional information 1.2.3 with protection perimeter zones 1.2.2. The protection perimeter zones are formed as areas inside a fixed two-dimensional distance from the structures, and extruded vertically from ground level to height that is higher than the maximum expected vegetation height in the area. Some vegetation information 1.2.1 are visible. Ground level 1.2.4 is also presented.

FIG. 3 shows additional examples of embodiments of structure perimeter geometries are disclosed. Bottom projections of structures 1.3.3 with protection perimeter zones 1.3.2. The protection perimeter zones are formed as areas inside a fixed three-dimensional distance from the structures, starting from ground level. Some vegetation information 1.2.1 are visible. Ground level 1.2.4 is also presented.

The information about the fire risk can be used multiple ways in the management of fire risk to structure. One example is to use it in insurance business to analyze the risk to structure when making a new insurance or updating insurance rating. Information about risk level, acquired from different sources, has been commonly used when deciding if an insurance can be awarded to a structure, but also to decide the right insurance cost rating.

Another example of using the information about fire risk to structure is to identify need for vegetation reduction or removal to control the fire risk.

One more application to use the information is in fire suppression; the fire suppression crew or management commonly faces a question about defendability of a given structure, for example a house. If a given house is deemed non-defendable of a certain fire in some given conditions, the decision may be, for example, to evacuate human and animal life from the structure and let it burn if it happens so, to prevent additional risk to life. Alternatively, the decision may be to assign resources to save the structure. On the other hand, if the structure owner or manager had used similar risk information earlier, and removed some vegetation around the structure, he/she might have changed the fuel condition and caused the same structure to be rated defendable because of the lower risk of fire spreading to the structure.

The above described methods may be implemented as computer software which is executed in a computing device that can be connected to the Internet. When the software is executed in a computing device it is configured to perform a method described above. The software is embodied on a computer readable medium, so that it can be provided to the computing device.

As stated above, the components of the exemplary embodiments can include a computer readable medium or memories for holding instructions programmed according to the teachings of the present embodiments and for holding data structures, tables, records, and/or other data described herein. The computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the method to quantify fire risk to structures may be implemented in various ways. The method to quantify fire risk to structures and its embodiments are thus not limited to the examples described above; instead they may vary within the scope of the claims.

1. A method of quantifying fire risk to structures which method comprising:
Receiving locations of structures of interest;
Receiving vegetation information;
Producing geometric perimeter zones to a proximity of the structures of interest;
Summarizing vegetation information within the produced geometric perimeter zones; and
Analyzing fire risk to the structures of interest based on summarized vegetation information.

2. The method according to claim 1, wherein the vegetation information is data received from remote sensing.

3. The method according to claim 2, wherein at least a portion of the vegetation information is derived from data acquired by LiDAR sensor.

4. The method according to claim 2, wherein at least a portion of the vegetation information is derived from data acquired by photogrammetry.

5. The method according to claim 1, wherein the method further comprising:
Receiving protection perimeter zone type and width;
Producing the geometric perimeter zones according to the received perimeter zone type and width; while still summarizing the vegetation information within the produced geometric perimeter zones; and
Analyzing fire risk to the structures of interest based on summarized vegetation information.

6. The method according to claim 1, wherein the summarizing of the vegetation information is done using an optimization algorithm to find at least one path for fire to cross the geometric perimeter zone to the structure of interest.

7. The method according to claim 1, wherein the method further comprising:
Receiving a reference measurement;
Performing Model Calibration between Summarized vegetation information and the Reference Measurement; and
Performing calibrated fire risk quantification calculation.

8. A system comprising at least one processor and data communication connection, wherein the system is configured to perform the method according to claim 1.

9. A computer program comprising computer program code, wherein the computer program is configured to cause a computing device to perform the method according to claim 1 when the computer program is executed in a computing device.
